(19) United States
(12) Patent Application Publication
(10) Pub. No.: US 2008/0063411 A1
(43) Pub. Date: Mar. 13, 2008

(54) Photonics-based Multi-band Wireless Communication System

(75) Inventors: Panos C. Lekkas, Worcester, MA (US); Raluca Dinu, Redmond, WA (US)

Correspondence Address: FISH & RICHARDSON P.C., PO BOX 1022, MINNEAPOLIS, MN, 55440-1022, US

(73) Assignee: LUMERA CORPORATION, Bothell, WA (US)

(21) Appl. No.: 11/672,436

(22) Filed: Feb. 7, 2007

Related U.S. Application Data
(60) Provisional application No. 60/843,807, filed on Sep. 11, 2006.

(51) Int. Cl. H04B 10/04

(52) U.S. Cl. 398/187

(57) ABSTRACT

Systems for wireless communication may select a photonic signal to generate a carrier frequency for wireless communication. In an illustrative example, the selected photonic signal may have sidebands with a frequency difference corresponding to a carrier frequency within one of multiple predetermined carrier frequency bands. In some implementations, each of the predetermined carrier frequency bands may contain a local minimum signal attenuation characteristic over a signal path of the wireless communication. For example, the selection of the photonic signal may be based on predetermined selection criteria such as error information, and/or signal path conditions (e.g., atmospheric humidity level, noise, signal strength). Apparatus for performing such methods may include a wireless communication system with a transmitter and/or receiver.

### CROSS-REFERENCE TO RELATED APPLICATIONS

This application claims priority under 35 U.S.C. § 119(e) to U.S. Provisional Patent Application Ser. No. 60/843,807, entitled “Wireless Communication” by Lekkas et al., which was filed on Sep. 11, 2006, and which is incorporated herein by reference.

This application is related to co-pending U.S. patent application Ser. No. (To be assigned), entitled “Photonics-based Multi-band Wireless Communication Methods” by Lekkas et al., which was filed on Feb. 7, 2007.

### TECHNICAL FIELD

Various embodiments relate to methods for providing high frequency wireless communication using photonics-based signal processing.

### BACKGROUND

In general, communication involves sending and receiving signals among two or more parties. In typical wireless communication systems, signals propagate through at least one medium that does not include a signal propagating through a wire conductor or an optical fiber. Wireless signals may propagate through various media, such as air, space, or water, for example.

As an example, a typical radio communication system includes a transmitter and a receiver that are separated by a medium. At the transmitter, a sinusoidal carrier voltage signal may be modulated to encode “baseband” information. The transmitter may transmit the modulated carrier signal so that it passes through the medium and is received by the receiver. At the receiver, an inverse operation may be performed to demodulate the carrier signal so that the original baseband information may be recovered. Accurate recovery of the original baseband information may be a function of factors such as distance, channel noise, and interference conditions.

Various modulation and coding techniques have been developed for wireless communications. For example, a transmitter may modulate a carrier signal's amplitude, frequency, or phase, or a combination thereof. Some transmitter systems may further use coding techniques by which specific characteristics of the carrier signal are modulated to represent desired symbols (e.g., numbers, letters, etc . . . ). A receiver may perform corresponding demodulation and decoding operations to recover the symbols.

### SUMMARY

Systems for wireless communication may select a photonic signal to generate a carrier frequency for wireless communication. In an illustrative example, the selected photonic signal may have sidebands with a frequency difference corresponding to a wireless carrier frequency within one of multiple predetermined wireless carrier frequency bands. In some implementations, each of the predetermined wireless carrier frequency bands may contain a local minimum signal attenuation characteristic over a signal path of the wireless communication. For example, the selection of the photonic signal may be based on predetermined selection criteria such as error information, and/or signal path conditions (e.g., atmospheric humidity level, noise, signal strength). Apparatus for performing such methods may include a wireless communication system with a transmitter and/or receiver.

In an illustrative example, a wireless communication system may generate an optical signal corresponding to a selected wireless carrier frequency, modulate the optical signal with a data stream, convert the modulated optical signal to a modulated electrical signal having the selected wireless carrier frequency, and transmit the modulated electrical signal over a wireless link through an antenna. In some embodiments, a receiver may receive the transmitted signal and perform substantially inverse operations with respect to the operations performed in the signal transmission.

In one exemplary aspect, a transmitter may wirelessly transmit data at carrier frequencies of about any of 35 GHz, 94 GHz, 140 GHz, and 220 GHz. Any combination of the carrier frequencies may be used for simultaneous transmissions. When two or more carrier frequencies are transmitted simultaneously, each carrier frequency may carry the same data or different data from all other simultaneously transmitted carrier frequencies. In some applications, data may be transmitted at only one of the carrier frequencies at any given point in time. In some embodiments, the transmitter may include a switch that sets the carrier frequency to a frequency selected from about 35 GHz, 94 GHz, 140 GHz, or 220 GHz.

In another exemplary aspect, a communication system may include: a) a transmitter that can wirelessly transmit data at carrier frequencies of 35 GHz, 94 GHz, 140 GHz, and 220 GHz, but transmits at only one of the carrier frequencies at any given point in time; b) a switch that sets the carrier frequency to 35 GHz, 94 GHz, 140 GHz, or 220 GHz; and, c) a receiver that receives the data.

In another exemplary aspect, a method may include: a) changing the carrier frequency of a wireless data transmission from a first carrier frequency selected from 35 GHz, 94 GHz, 140 GHz, or 220 GHz to a different second carrier frequency selected from 35 GHz, 94 GHz, 140 GHz, or 220 GHz based on predetermined selection criteria.

In another exemplary aspect, a method may include: a) changing the carrier frequency of a wireless data transmission from a first carrier frequency selected from 35 GHz, 94 GHz, 140 GHz, or 220 GHz to a different second carrier frequency selected from 35 GHz, 94 GHz, 140 GHz, or 220 GHz, wherein the wireless data transfer has a data transfer rate and a bit error rate and the carrier frequency is changed to maximize the data transfer rate and maintain the bit error rate at less than a predetermined level.

Some embodiments may have one or more of the following advantages. For example, some optically-based systems may provide improved reliability and/or reduced power consumption. Some embodiments may facilitate, for example, line-of-sight applications for very-high-speed wireless connectivity. Certain embodiments may provide for practical replacement of fiber optic links at reasonable cost levels. In some examples, optically-based wireless transceivers may provide high data rates while consuming relatively low power. Moreover, systems with such optically-based transceiver systems may be implemented using various levels of integration. Some systems may advantageously achieve high data rates (e.g., up to and above 10 Gbps (gigabits per second)), and may yield improvements that include, but are not limited to, reductions in size, weight, power consumption, equipment failure rate, and/or manufacturing cost of the systems.

The details of one or more embodiments are set forth in the accompanying drawings and the description below. Other features, objects, and advantages will be apparent from the description and drawings, and from the claims.

### DESCRIPTION OF DRAWINGS

FIG. 1A is a block diagram of an example transmitter for a wireless communication system.

FIG. 1B is a frequency spectrum plot of example of optical signal components as may be produced, for example, in the transmitter of FIG. 1A.

FIG. 2 is a block diagram of an example transmitter with an N×1 optical combiner.

FIG. 3 is a block diagram of an example transmitter with a broadband antenna.

FIG. 4 is a block diagram of an example transmitter with a broadband photodiode.

FIG. 5 is a block diagram of an example photonic signal generator and associated circuitry for a transmitter.

FIG. 6A-F are time and frequency domain plots for example signals as may be processed, for example, in the transmitter of FIG. 1A.

FIGS. 7-9 are block diagrams of example photonic signal generators with associated circuitry for a transmitter.

FIG. 10 is a block diagram of an example transmitter with a photonic true-time delay module.

FIGS. 11-13 are block diagrams of example receivers for wireless communication systems.

FIG. 14 is a flow chart of exemplary operations for a supervisory adaptive management and control engine for wireless communication system.

Like reference symbols in the various drawings indicate like elements.

### DETAILED DESCRIPTION OF ILLUSTRATIVE EMBODIMENTS

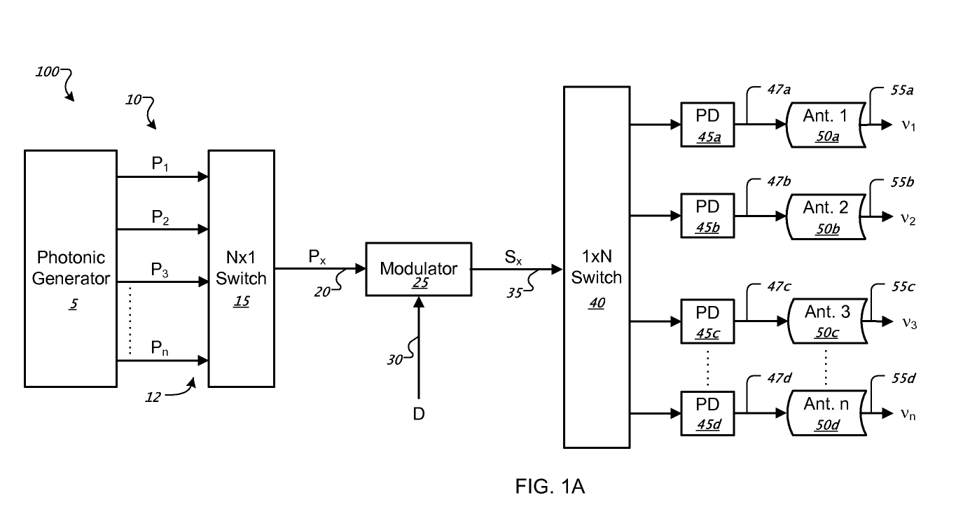

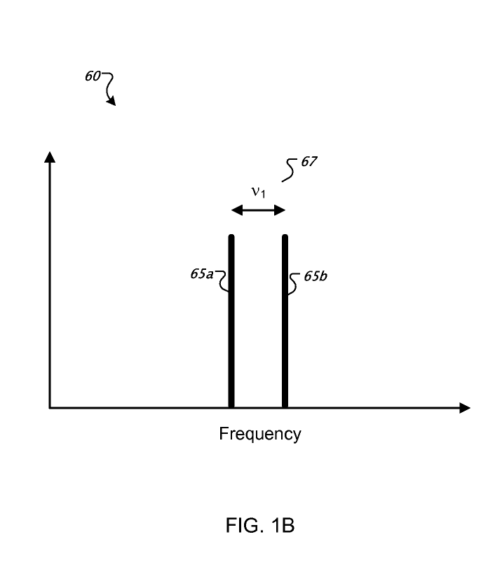

FIG. 1A shows an example transmitter 100 for a wireless communication system. The transmitter 100 uses photonic signal processing to provide an optical signal with components (e.g., sidebands) having a frequency difference corresponding to a carrier frequency in a selected carrier frequency band (sometimes herein this is referred to as “an optical signal corresponding to a carrier frequency” and the like). In operation, the transmitter 100 selects an optical signal that has a frequency in a selected frequency band. The transmitter 100 encodes data onto the selected optical signal. An opto-electronic conversion converts the selected optical signal to an electrical format for wireless transmission. The difference in frequency of the components of the selected optical signal becomes the carrier frequency of the wireless transmission. In such systems, the transmitter 100 may perform high speed wireless data transfers (e.g., up to and above 10 Gbps) using carrier frequency band selection, for example, to improve effective data rates. As an illustrative example, changes to the selected carrier frequency band may be made during high speed data transfer operations, for example, to maintain a desired bit error rate performance and/or reduce power consumption in the transmitter 100.

In the example depicted in FIG. 1, the transmitter 100 includes a photonic signal generator 5, an N×1 switch 15, a data optical modulator 25, a 1×N switch 40, photodiodes 45a-45d, and antennas 50a-50d. The photonic signal generator 5 can generate a plurality of optical signals 10, (e.g., P₁-Pₙ). The N×1 optical switch 15 selects one of the plurality of optical signals 10 received on input ports 12 to give a selected optical signal Pₓ 20, (e.g., where x is an integer between 1 and n). The data optical modulator 25 encodes data 30 on the optical signal 20 resulting in a modulated optical signal Sₓ 35.

The photodiodes 45a-45d convert an optical signal received from the 1×N switch 40 to a corresponding modulated electrical signal on a selected one of nodes 47a-47d respectively. The modulated electrical signal on the selected one of the nodes 47a-47d is coupled to a corresponding one of antennas 50a-50d. The antennas 50a-50d transmit a wireless signal at a selected one of carrier frequencies 55a-5d, which corresponds to a difference in frequency of components of the selected optical signal Pₓ 20.

In an illustrative example, the N×1 switch 15 may select the optical signal P₁, corresponding to the carrier frequency v₁. After the selected optical signal P₁ is modulated by the data 30, the 1×N switch 40 may route the modulated optical signal to the photodiode 45a. The photodiode 45a converts the modulated optical signal to a modulated electrical signal on the node 47a, which is coupled to the antenna 50a. The antenna 50a wirelessly transmits at the selected carrier frequency 55a, v₁.

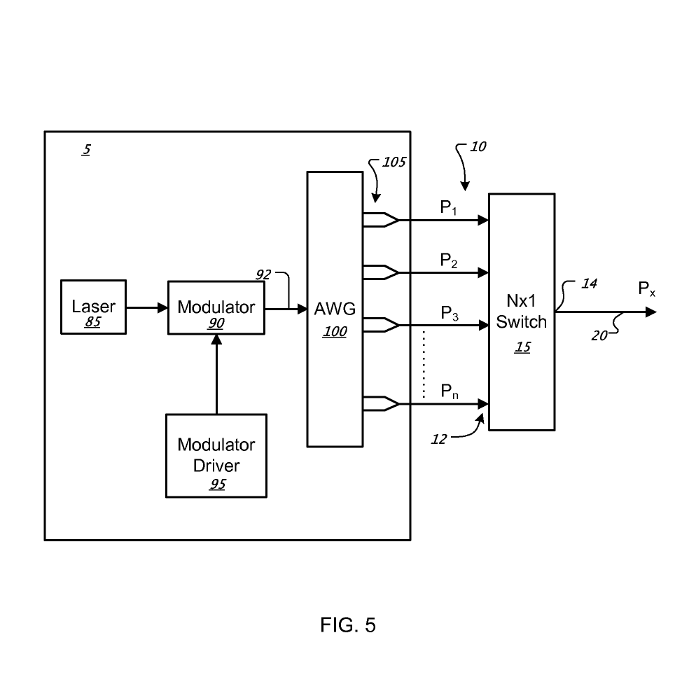

The photonic signal generator 5 may use techniques such as, for example, those described in A. Hirata, et al. IEICE Trans. Electron. E88-C (No. 7), 1458-1464 (2005) to generate the optical signals 10. Other techniques that may be used to generate the optical signals 10 will be described in further detail, for example, with reference to FIG. 5.

The N×1 switch 15 that selects the optical signal 20 may be, for example, an electro-optic or thermo-optic waveguide switch. Many variations of optical switches are known in the art of photonics, especially in optical add-drop multiplexer subsystems. Some optical switches may provide high isolation between the N-input channels such that an optical signal at the exit port couples substantially only to an optical signal received at a selected one of the N-input ports 12. In the depicted example, the N×1 switch 15 may provide isolation between the input ports 12 when the photonic signal generator 5 simultaneously supplies two or more optical signals 10, or any combination thereof, to the input ports 12. In some examples, the optical switch 15 may include directional couplers that are combined into a network. In various embodiments, the N×1 optical switch 15 may provide for selection of the wireless carrier frequency.

The data optical modulator 25 may be any optical modulator capable of encoding data on the optical signal 20. Examples of optical modulators include, but are not necessarily limited to, electro-optic lithium niobate modulators, electro-optic polymer modulators, and electro-absorptive modulators. The data optical modulator 25 may modulate the amplitude and/or phase of the optical signal. The data 30 may be an analog and/or digital signal.

The 1×N switch 40 may be an electro-optic or thermal optic switch. An example of such a switch was described above with reference to the N×1 switch 15. In operation, the 1×N switch 40 routes the modulated optical signal 35 to a selected one of the photodiodes 45a-45d.

FIG. 1B shows an exemplary spectrum 60 that includes optical signals 65a, 65b in the transmitter 100 of FIG. 1A. In some examples, the optical signals 65a, 65b represent two side band components. In an illustrative example, the signals 65a, 65b may have a difference in frequency 67 (e.g., v₁). In various embodiments, the frequency difference 67 may correspond to a carrier frequency (e.g., 35, 94, 140, or 220 GHz) suitable for wireless transmission. For example, referring to FIG. 1A, when the modulated optical signal 35 impinges on the photodiode 45a, the photodiode 45a generates an electrical signal 47a with a carrier frequency 55a that matches the frequency difference of the signals 65a, 65b. The modulated electrical signal 47a is fed into an antenna 50a that wirelessly transmits the modulated electrical signal 47a at the selected carrier frequency 55a.

In some embodiments, the photodiodes 45a-45d and respective antennas 50a-50d may be responsive to a specific carrier frequency and/or a predetermined carrier frequency band. In an example embodiment, the photodiodes 45a-45d may be adjustable in response to a control signal. For example, a control signal may be applied to adjust the photodiode to respond with a substantially flat frequency response over all or at least a portion of the frequency band that includes the carrier frequency and/or difference frequency components used to generate the carrier frequency. Some embodiments may incorporate active and/or passive circuits (e.g., amplifiers, frequency selective filter circuits) to achieve selected and/or adjustable frequency response characteristics. In various implementations, each photodiode and antenna within the transmitter 100 may be unique. For example, photodiode 45a, which generates electrical signal 47a, which produces carrier frequency 55a, may be manufactured with different materials and of a different structure than photodiode 45b, which is used to generate electrical signal 47b to produce carrier frequency 55b. The photodiodes 45a-45d may include, for example, an ultrafast, semi-conductor uni-traveling carrier photodiode, although other types of photodiodes may be suitable. The antennas 50a-50d for each of the carrier frequencies 55a-50d may also be manufactured and selected for optimized performance at the selected carrier frequency for each antenna 50a-50d to transmit. The antennas 50a-50d may include, but are not limited to, a Cassegrain antenna or a dielectric antenna, for example.

In the depicted example, the transmitter 100 (FIG. 1) includes four photodiodes 45a-45d coupled to transmit at any of four different carrier frequencies using four corresponding antennas 50a-50d. In various embodiments, the transmitter may include more than or less than four photodiode/antenna coupled pairs enabling it to transmit at more than or less than four different carrier frequencies.

In some embodiments, the components of the transmitter 100, the N×1 switch 15, the data optical modulator 25, the 1×N switch 40, and the photodiodes 45a-45d, may be patched together with optical fiber. In some other embodiments, the N×1 switch 15, the data optical modulator 25, and the 1×N switch 40 may be integrated on one electro-optic substrate.

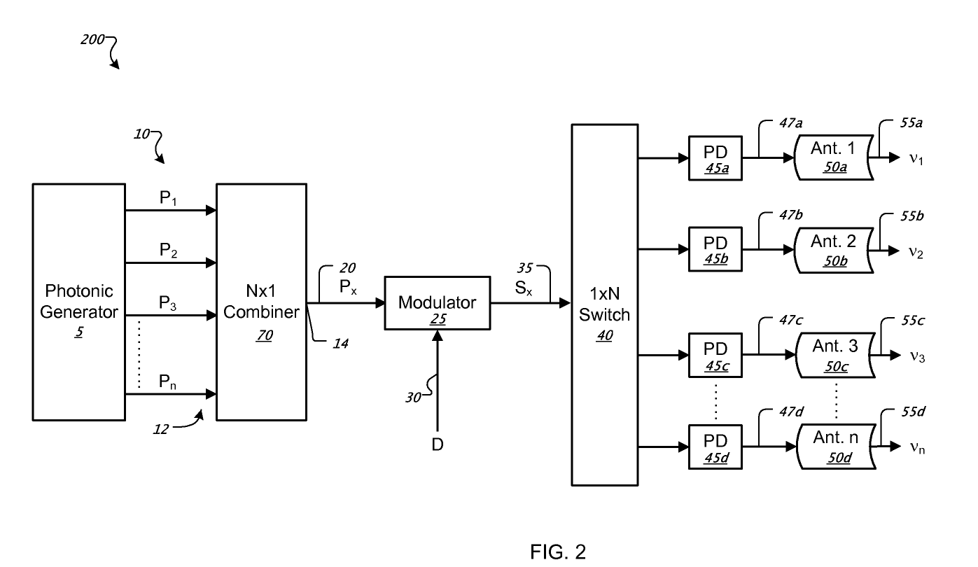

FIG. 2 shows an example of a transmitter 200, which includes an N×1 optical combiner 70. Transmitter 200 includes photonic signal generator 5, N×1 optical combiner 70, data optical modulator 25, 1×N switch 40, photodiodes 45a-45d, and antennas 50a-50d. The transmitter 200 functions in a similar manner as the transmitter 100, described with reference to FIG. 1A. The N×1 optical combiner 70 is included in transmitter 200 in place of N×1 switch 15 included in transmitter 100. The N×1 optical combiner 70 is used to route any one of the optical signals 10 received on the input ports 12 to an output port 14. In particular, the selected optical signal 20 (e.g., Pₓ) is supplied to the output port 14.

In this example, the photonic signal generator 5 may generate any one of the optical signals 10 (e.g., P₁-Pₙ) with sidebands having a frequency difference corresponding to the desired carrier frequency for the transmitter 200, but not substantial amounts of any other sidebands corresponding to non-desired carrier frequencies. Various methods, or combinations of methods, may be used to generate the sidebands. One or more types of optical filters may be used, for example.

In some examples, the electronic and/or photonic circuitry of the photonic signal generator 5 may produce substantially only the sidebands corresponding to the desired carrier frequency. This effectively provides the selection of the wireless carrier frequency. In some embodiments, the N×1 switch provides isolation (e.g., up to 18 dB or more) among the signals P1, P2, P3, for example.

In some embodiments, a combiner may be used to generate the optical signal Pₓ 20. In some examples, an N×1 combiner may generate P1 (or P2 or P3) directly from appropriate signals supplied by the photonic generator. Accordingly, some implementations may not include an N×1 optical switch.

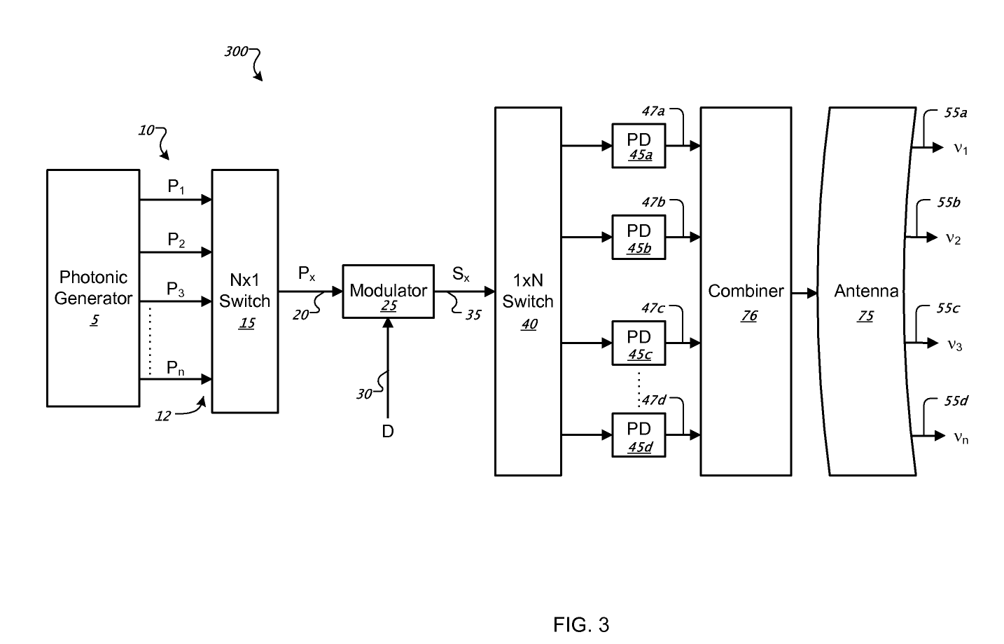

FIG. 3 shows an example of a transmitter 300, which includes a broadband antenna 75 and a combiner 76. The 1×N switch 40 is used to route the modulated optical signal 35 to photodiodes 45a-45d. The photodiodes 45a-45d may each be selected to respond to a particular frequency range that corresponds to a wireless carrier frequency bands (e.g., centered near 35, 94, 140, or 220 GHz). The photodiodes 45a-45d may generate modulated electrical signals 47a-47d, respectively. A selected one of the electrical signals may correspond to a wireless carrier frequency. The modulated electrical signals 47a-47d are routed through the combiner 76. The output of the combiner 76 is coupled to the broadband antenna 75. The broadband antenna 75 is capable of transmitting any or all of the wireless carrier frequencies the photodiodes 45a-45d have been selected for (e.g., v₁=35 GHz, v₂=94 GHz, v₃=140 GHz, or V₄=220 GHz). In some implementations, more than one frequency may be transmitted simultaneously.

In another embodiment of transmitter 300, the electrical signals 47a-47d output from photodiodes 45a-45d respectively may be separately coupled to the broadband antenna 75 without being routed through the combiner 76. For example, feed paths for each of the electrical signals 47a-47d may be sufficiently isolated from each other to drive different inputs of the antenna 75. In an exemplary configuration with a single antenna, a signal in each of a number of feed paths may couple to a corresponding millimeter-wave power amplifier that is selectively capable of handling a selected carrier frequency (e.g., 140 GHz, 34 GHz, etc.). In one embodiment, a controller associated with the broadband antenna 75 may be capable of determining which input electrical signal 47a-47d contains the carrier frequency to be transmitted. In another embodiment, a controller may activate a digital multi-throw switch in the photonic generation process.

The control may be based on which signal is being generated. The switch may be activated electronically, for example, by the controller writing a few specific bits to a control register to switch and/or to enable the appropriate input.

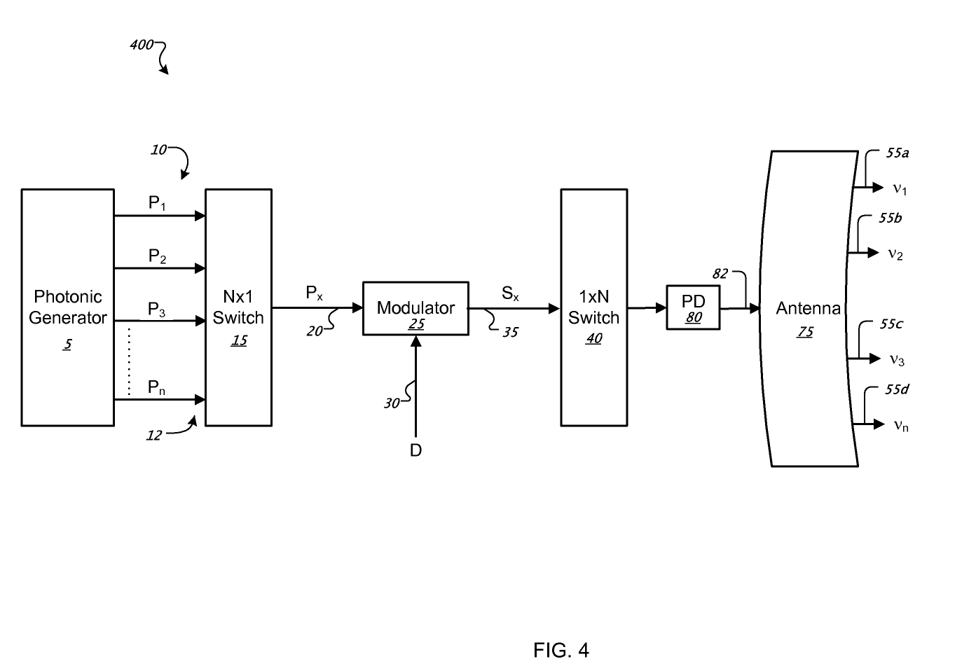

FIG. 4 shows an example of a transmitter 400, which includes a broadband photodiode 80. Transmitter 400 includes photonic signal generator 5, N×1 switch 15, data optical modulator 25, 1×N switch 40, broadband photodiode 80, and broadband antenna 75. The transmitter 400 functions in a similar manner as the transmitter 300, described with reference to FIG. 3. The modulated optical signal 35 is coupled to a broadband photodiode 80. The broadband photodiode 80 can generate an electrical signal 82 in response to any of the optical signals 10 selected by the N×1 switch 15. This criterion is used in the selection of the broadband photodiode 80 for use in transmitter 400. The electrical signal 82 is coupled to the broadband antenna 75, which transmits the selected carrier frequency.

FIG. 5 shows an example of the photonic signal generator 5 in an exemplary transmitter. The photonic signal generator 5 includes a laser 85, a signal optical modulator 90, a modulator driver 95, an arrayed waveguide grating (AWG) 100, and optical combiners 105 at selected outputs of the AWG 100.

The laser 85 can be of any suitable wavelength. For example, the laser 85 may have a wavelength of about 1310-1550 nm. This range of wavelengths may advantageously provide a variety of useful optical components. The signal optical modulator 90 can be, but is not necessarily limited to, any of the modulators used for the data optical modulator 25, an example of which is described with reference to FIG. 1A.

The AWG 100 can be used, for example, to channelize the sidebands by their frequency. Once the frequencies are channelized, they may be combined to give sideband pairs at the inputs of the N×1 switch 15. The sideband pairs each have a frequency difference corresponding to one of the desired carrier frequencies.

The optical combiners 105 are located at selected outputs of the AWG 100. The optical combiners 105 may be integrated in the same planar lightwave circuit (PLC) chip as the AWG 100. Various techniques may be used by the photonic signal generator 5 to generate a spectrum 60 with optical signals 65a, 65b having a frequency difference 67 (e.g., v₁), as discussed with reference to FIG. 1B. Exemplary aspects such techniques are described, for example, in A. Hirata, et al. IEICE Trans. Electron. E88-C (No. 7), 1458-1464 (2005) or A. Hirata et al., J. Lightwave Technol. 21(10), 2145-2153 (2003), the contents of both of which are incorporated herein by reference. In some examples, a frequency difference 67 corresponds to the desired wireless carrier frequency, where v₁ may be, for example, within carrier frequency bands substantially centered near 35, 94, 140, and/or 220 GHz, for example.

Such center frequencies may be in various frequency ranges. In one example, a system may be configured to transmit a signal using 10 GHz of spectral bandwidth centered at 35 GHz. In another example, which may use a relatively relaxed signal source encoding, a system may be configured to encode the same signal for transmission using 20 GHz of spectral bandwidth substantially between 25-45 GHz. In some implementations, a government entity (e.g., Federal Communications Commission (FCC)) may impose limitations on certain transmissions. The constraints may depend on various factors, such as spectral bandwidth, frequency ranges, and/or power levels, for example. In an illustrative example, fewer regulatory constraints may be imposed at certain frequencies (e.g., around 140 GHz). In some embodiments, a system may re-encode a similar source signal to within a bandwidth of about 5 GHz or even less, for example.

In various implementations, a Mach-Zehnder modulator may split one optical wave into two waves and then synthesize back into one wave again to induce optical interference. It relies on two physical effects to vary the light intensity. These are an electro-optic (EO) or Pockels effect and optical interference. A refractive index change results when an electrical field is applied to a material. The effect of the linear relationship between this refractive index change and an applied electrical field is called the first order electro-optic effect (e.g., Pockels effect). Optical interference is a phenomenon whereby two optical waves overlap thus intensifying or diminishing their amplitudes. The Mach-Zehnder structure consists of an input optical branch (which splits the incoming light into two arms) followed by two independent optical arms (which are subsequently recombined by the output optical branch). Application of an electrical signal to one of the optical arms controls the degree of interference at the output optical branch and therefore controls the output intensity.

In an embodiment of the photonic signal generator 5, a Mach-Zehnder modulator can be implemented for signal optical modulator 90. When a Mach-Zehnder modulator can be modulated at a given frequency, for example X GHz, then the optical spectrum of the output will have at least two optical sidebands at ±X GHz from the optical center wavelength. If the optical carrier is removed by optical filtration, for example, then the optical spectrum of optical signal 60 will include sidebands represented by signals 65a, 65b, which are separated by twice the X GHz used for modulation. Using this technique, an optical signal 20 Px can be generated that corresponds to a desired wireless carrier frequency for transmitter 100. For example, the optical signal output by the laser 85 can be modulated with a frequency of 47 GHz, which will give sidebands having a frequency difference of 94 GHz. Filtering out the optical carrier frequency yields the sidebands 65a, 65b of the optical signal that are separated, in this example, by 94 GHz.

In another embodiment, a carrier-suppression modulation method may be used with a Mach-Zehnder modulator as the signal optical modulator 90. The carrier-suppression modulation method can be used to decrease the intensity of the carrier without substantially attenuating the sidebands of the optical signal 92 before it is input to AWG 100. In some embodiments, the carrier suppression modulation method may include biasing the signal optical modulator 90 at or near its maximum extinction point.

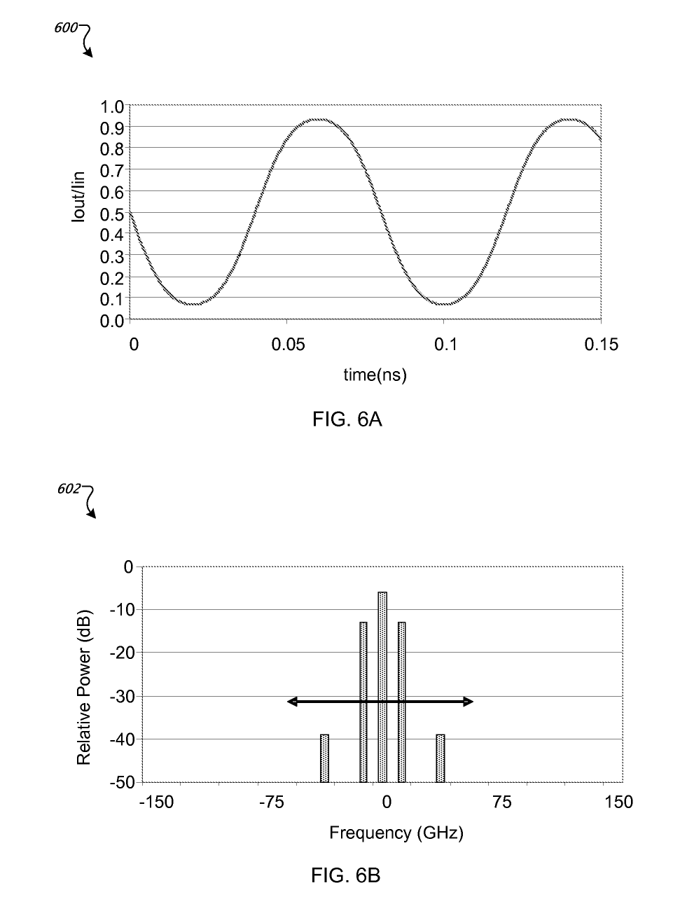

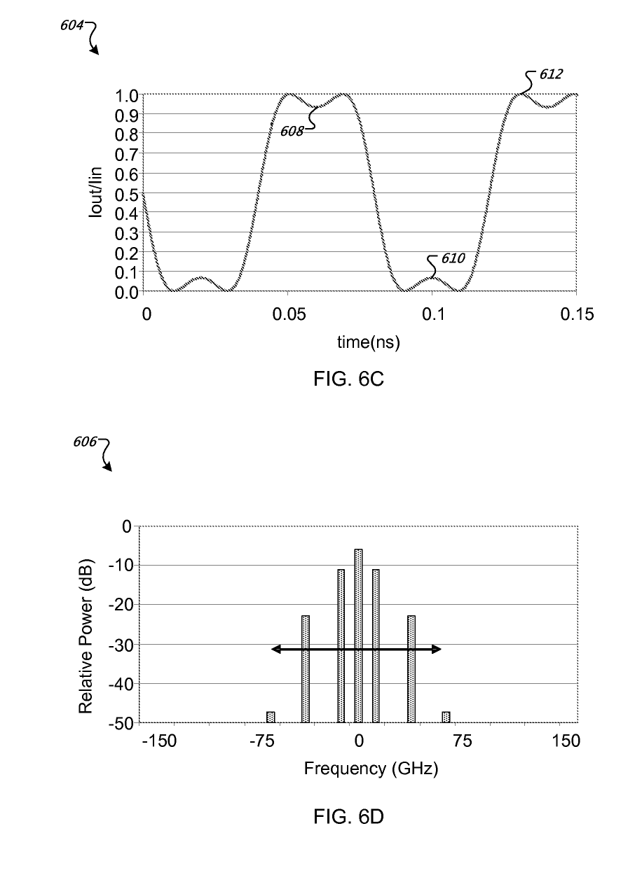

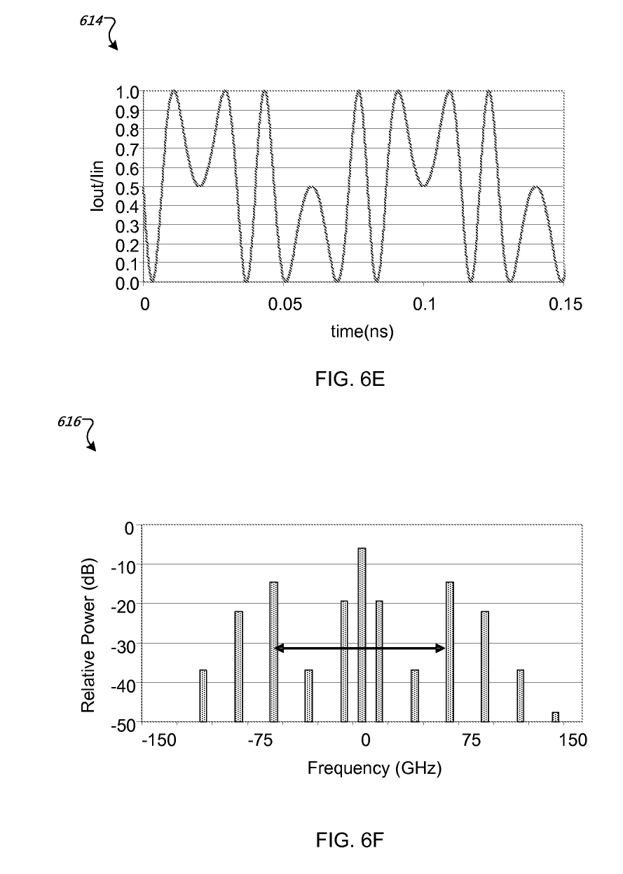

FIG. 6A-F show examples of time and frequency domain plots for optical signals in an embodiment in which the signal optical modulator is overdriven. In this implementation, a Mach-Zehnder modulator is used for signal optical modulator 90, shown with reference to FIG. 5, which is overdriven through its RF electrode by an appropriate drive signal.

FIG. 6A and FIG. 6B show example plots of a transfer function of an example Mach-Zehnder modulator in the time domain 600 and frequency domain 602, respectively. The transfer function (e.g., optical intensity vs. time) follows the sinusoidal driving signal when the modulating voltage (Vm) is less than the half-wave voltage (Vpi) at a particular bias point (Vbias/Vpi). In this example, the drive frequency is equal to 12.5 GHz, Vm/Vpi is equal to 0.33 and the bias point (Vbias/Vpi) is equal to 0.50.

FIGS. 6C and 6D show example plots of a transfer function of an example Mach-Zehnder modulator in the time domain 604 and the frequency domain 606, respectively, as the modulator starts to become overdriven. The modulator 90 starts to become overdriven as the modulating voltage (Vm) is increased (e.g., drive frequency=12.5 GHz, Vm/Vpi=0.67, Vbias/Vpi=0.50). Overdriving the modulator 90 results in a downturn in the peak 608 or an upturn in the valley 610 of the sinusoidal transfer function 612.

FIGS. 6E and 6F show example plots of a transfer function of an example Mach-Zehnder modulator in the time domain 614 and the frequency domain 616, respectively, as the modulator is increasingly overdriven. The time domain plot 614 changes and becomes more complicated than the time domain plot 604 as the modulator becomes increasingly overdriven. Overdriving the modulator is accomplished by again increasing the modulating voltage (Vm) (e.g., signal frequency=12.5 GHz, Vm/Vpi=2.00, Vbias/Vpi=0.50). As shown with reference to FIG. 5, overdriven electro-optic (EO) modulators, for example, modulator 90, can produce sidebands to the specific frequency of the laser, for example laser 95, which feeds their input. In various embodiments, the sidebands may be located at some integer multiple(s) of the drive frequency (e.g., 2×, 3×, 4×, the drive frequency from the optical center wavelength). The frequency domain plots 602, 606 and 608, show how 95 GHz. separated sidebands can be produced. FIG. 6F shows the 95 GHz. Sidebands produced by driving the modulator at a drive frequency of 12.5 GHz. with a Vm/Vpi=2.00 and Vbias/Vpi=0.50.

Specific relationships between drive frequency, the half-wave voltage (Vpi), the modulating voltage (Vm), and the bias point (Vbias/Vpi) can allow for different photonic signal generator configurations based on either the odd or even harmonics of a laser signal input into the signal optical modulator. For example, overdriving a modulator at a frequency of 17.5 GHz may yield the following: a first pair of sidebands each 17.5 GHz from the optical center wavelength (35 GHz difference); a second pair of sidebands each 35 GHz from the optical center wavelength (70 GHz difference); third pair of sidebands each 52.5 GHz from the optical center wavelength (105 GHz difference); and a fourth pair of sidebands each 70 GHz from the optical center wavelength (140 GHz difference). In some embodiments of FIG. 5, the driving signal for the signal optical modulator 90 may be selected in conjunction with the AWG 100 filter configuration, and the choice of the N×1 switch 15 may influence which of the carrier frequencies is selected for wireless radio frequency (RF) transmission by a transmitter, and example of which was shown in FIG. 1A. Selected odd-order sidebands (e.g., 1st, 3rd, 5th, etc.) may be retained after passing through the AWG 100. Sidebands are selected by matching their respective spectral distance from each other, as shown with reference to FIG. 1B, with the selected RF carrier frequency for transmission.

FIG. 6A-6F show exemplary time and frequency domain plots for signals in a transmitter, for example, the transmitter of FIG. 1A. Overdriving an EO modulator can cause it to produce appropriate sidebands. The spectral distance among these sidebands can be used to generate millimeter-wave signals. The examples in FIG. 6A-6F show the relationship between the overdriving signal through the RF electrode in the EO modulator and the presence and size of various sidebands at the output of the EO modulator.

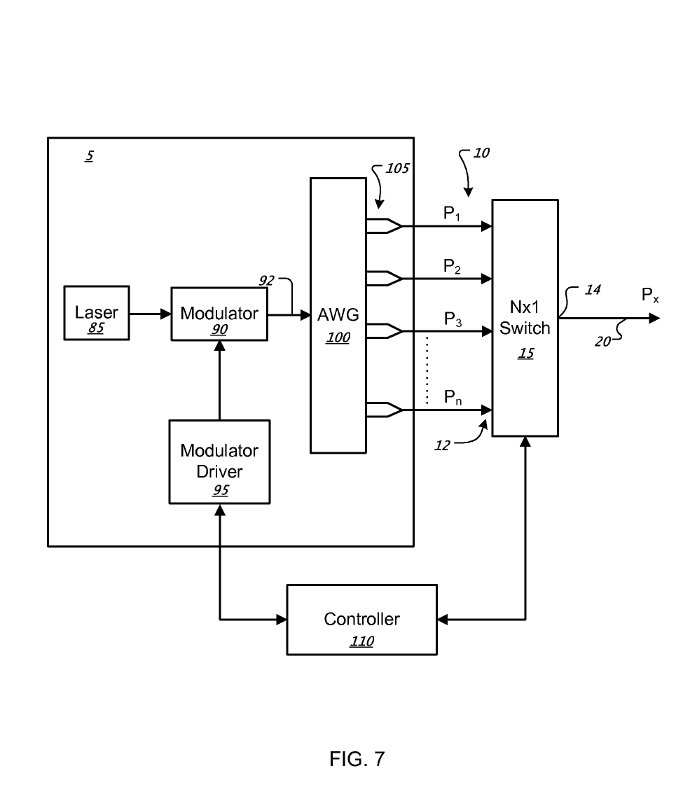

FIG. 7 shows an example of the photonic signal generator 5 and related circuitry in the transmitter of FIGS. 1A, 2, 3, and 4, with the addition of a first controller 110. The photonic signal generator 5 includes laser 85, signal optical modulator 90, modulator driver 95, arrayed waveguide grating (AWG) 100, and optical combiners 105 at selected outputs of the AWG 100. The N×1 switch 15 and the modulator driver 95 for the signal optical modulator 90 are coordinated by the first controller 110 to produce the optimal intensity of light in the sidebands for the given carrier frequency of choice. For example, when the N×1 switch 15 is changed to 94 GHz from 35 GHz, the modulation characteristics of the signal optical modulator 90 (e.g., drive frequency, modulating voltage (Vm), and bias point (Vbias/Vpi)) are changed to provide the maximum possible intensity of light in the 94 GHz separated sidebands. The first controller 110 coordinates this operation. The same process can be performed, for example, when the N×1 switch 15 is switched from 94 GHz to 140 GHz, for example, or when the N×1 switch 15 switches between any of the other many possible optical signals corresponding to a carrier frequency.

In some embodiments of a transmitter, the signal optical modulator 90 of the signal generator 5, shown with reference to FIG. 5, and the data optical modulator 25, shown with reference to FIGS. 1A, 2, 3, and 4, may both be equipped with a computer-controlled control loop that continuously monitors and adjusts each modulator's bias current drift independently.

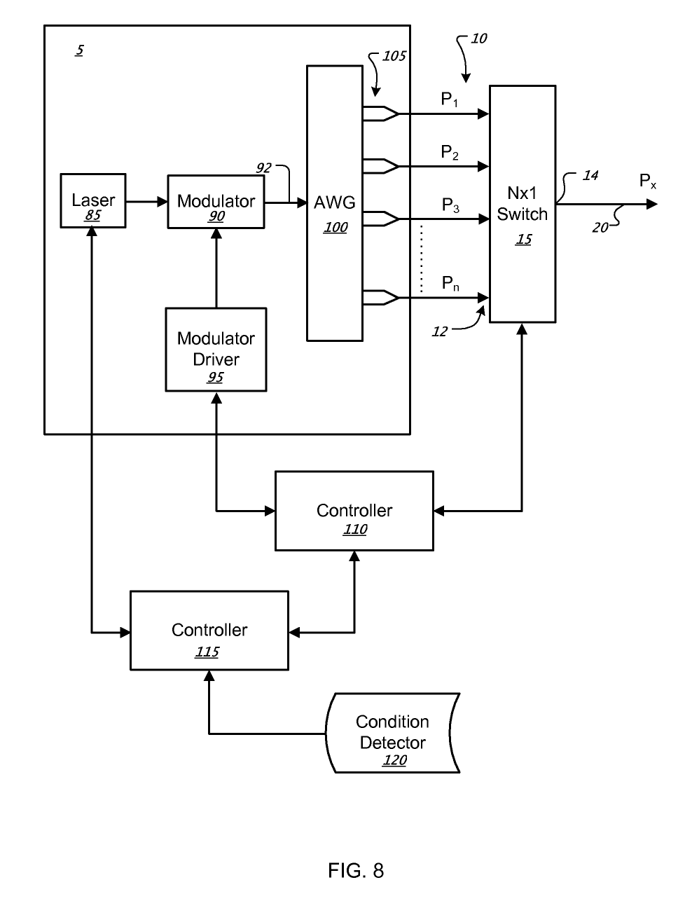

FIG. 8 shows an example of the photonic signal generator 5 and related circuitry in the transmitter of FIGS. 1A, 2, 3, and 4, with the addition of the first controller 110, a second controller 115, and a condition detector 120. The photonic signal generator 5 includes laser 85, signal optical modulator 90, modulator driver 95, arrayed waveguide grating (AWG) 100, and optical combiners 105 at selected outputs of the AWG 100. The second controller 115 coordinates the first controller 110, and the laser 85. A receiver (not shown) monitors the wireless RF signal strength at the carrier frequency selected for the transmitter, an example of which is shown with reference to FIG. 1A. The receiver may send to the condition detector 120 a predetermined signal if, for example, the wireless RF signal strength of the signal transmitted by the transmitter exhibits an unwanted change in condition. The condition controller 120 may then send a signal to the second controller 115. The second controller 120 may respond by, for example, making coordinated adjustments to the operation of the first controller 110 and the laser 85, and/or to the selected carrier frequency.

In an illustrative example, the second controller 115 may respond to a signal received from the condition detector 120 by coordinating a response in the transmitter based on changes in the weather or signal carrier frequency channel quality. Changes in the weather, such as humidity, for example, may cause more or less attenuation along the wireless signal path in one or more of predetermined carrier frequency bands. Some installations may receive carrier frequency channel quality information from a signal strength detector configured to detect power levels of the incoming RF signal at the receiver. Some installations may use digital error detection techniques such as error correction codes (ECC), cyclical redundancy check (CRC), and/or similar error detection methods. Some installations may use a combination of these or other techniques, such as a weather information from instruments or provided electronically through a communication network (e.g., cellular phone, radio, internet, virtual private network (VPN), local area network (LAN), metropolitan area network (MAN), or the like). In some examples, the receiver may send a predetermined signal, indicating the increase or decrease in the signal strength, to the condition detector 120. The condition detector 120 passes this predetermined signal to the second controller 115. The second controller 115 may respond to the predetermined signal by, for example, adjusting the power of the laser 85, changing the selected carrier frequency through the first controller 110, or by a combination thereof.

In an illustrative example, signal strength detectors at a receiver may detect an increase in the power of the incoming RF signal at the receiver. The receiver may send a predetermined signal, indicating the increase in the signal strength, to the condition detector 120. The condition detector 120 may pass this predetermined signal to the second controller 115. The second controller 115 may respond to the predetermined signal by lowering the power of the laser 85, changing the selected carrier frequency through the first controller 110, or by a combination thereof.

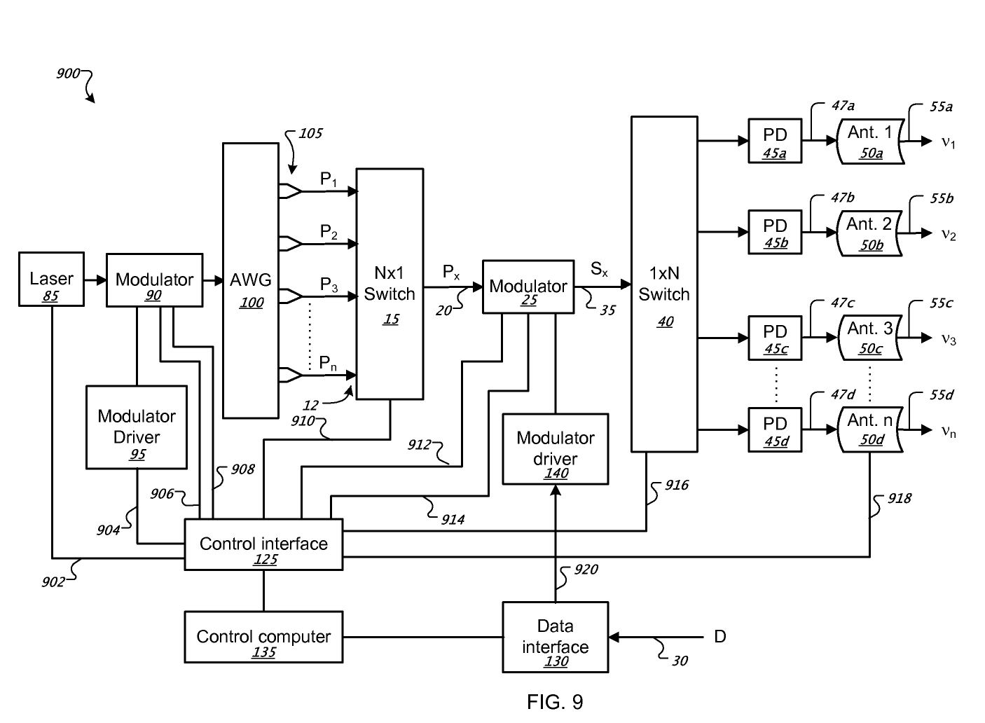

FIG. 9 shows an example of a transmitter, which includes additional control circuitry. The transmitter 900 functions in a similar manner as the transmitter 100, described with reference to FIG. 1A. The transmitter 900 includes a control interface 125, a data interface 130, a control computer 135, and a data modulator driver 140. The control computer 135 interacts with and directs the control interface 125 and the data interface 130. The control interface 125 may be in communication with and control one or more components of the transmitter 900.

The control interface 125 may serve various functions and purposes in the transmitter 900. In the depicted example, the control interface 125 is configured to control and/or monitor the operation (e.g., output power) of the laser 95 via a signal connection 902. The control interface 125 is configured to control the drive signal from the modulator driver 95 to the signal optical modulator 90. Using a signal connection 904 between the control interface 125 and the modulator driver 95, the control interface 125 can manipulate the modulator driver 95 to cause the modulator to generate desired frequency components to be filtered by the AWG 100. The control interface 125, using signal connection 906 between the control interface 125 and signal optical modulator 90, can control the bias point on the signal optical modulator 90. The operating point (e.g., output power level) of the signal optical modulator 90 can be monitored by the control interface 125, using signal connection 908 between the control interface 125 and signal optical modulator 90. The control interface 125 may monitor DC drift in the signal optical modulator 90. In some embodiments, the control interface and/or control computer 135 may provide open (e.g., feed forward based on temperature measurement) and/or closed-loop (e.g., feedback based on a fraction of the output power level) control to maintain a desired operating point. For example, output power may be accurately controlled over a wide range of temperatures, device parameters, supply voltages, and the like.

The control interface 125 can use a signal connection 910 between the control interface 125 and the N×1 switch 15 to operate the N×1 switch 15 to select the carrier frequency bands for wireless transmission. The control interface 125 can control the operating point of the data optical modulator 25 using a signal connection 912 between the control interface 125 and the data optical modulator 25. The operating point of the data optical modulator 25 can be reported to the control interface 125 via signal connection 914 between the control interface 125 and data optical modulator 25. The control interface 125, using signal connection 916 between the control interface 125 and 1×N switch 40, can control the 1×N switch 40 for signal routing based on the selected carrier frequency band. The control interface 125, using signal connection 918 between the control interface 125 and the antennas 50a-50d, can adjust the level of an optional power amplifier (not shown) coupled to drive one or more of the antennas 50a-50d.

The control interface 125 is linked to the control computer 135. In some embodiments, the control interface 125 may be a part of the controller 135 and reside, for example, on a plug-in card for a computer (e.g., a PCI card). The control interface may include, but is not limited to, systems such as USB, Infiniband, Rapid-IO, and the like.

The data interface 130 feeds the data (e.g., a baseband signal) through connection 920 to the data modulator driver 140. The data modulator driver 140 supplies the data to the optical modulator 25 to encode the data onto the optical signal 20.

The control computer 135 is also coupled to the data interface 130, which receives data 30 from a data source D, and supplies the received data to the modulator driver 140 via a signal 920. The data interface may have at least one processor and one or more data stores (e.g., L2 cache, L1 cache, RAM, registers, hard disc drive, flash memory, data buffer, or the like). The data source D may include, but is not limited to, streaming data sources (e.g., audio, video, multimedia, network traffic, bulk data transfers, and the like), data storage devices (e.g., volatile memory, non-volatile memory), processed information sources that output processed information (e.g., from computational operations), or a combination of these or other sources, which may be unpacketized or partially or completely packet-based in various embodiments.

In the depicted example of FIG. 9, the data interface 130 is separate from the control computer 135, although the data interface may be integrated with the control computer 135 and/or the data source D in some other examples. In operation, one CPU process may be handling data generation (e.g., from disk, memory, and/or an I/O adapter that supplies data to be transmitted), while another CPU process (e.g., on a 10 GbE NIC (network interface controller), or other I/O adapter) produces the actual signal 920. The data source D may be either inside the computer 135 or in another system. In various embodiments, the data interface 130 may add to and/or remove from the data certain information (e.g., packet header, wrapper, or trailer information, CRC (cyclical redundancy check) checksum values, ECC (error correction code) data, or the like). The data interface 130 may also perform packetizing services (e.g., add or strip wrapper or header information, error correction info, etc.), which may be, for example, in the 10 GbE environment. In an example, the transmitter 900 may receive for transmission non-packetized traffic of raw bits at up to at least about 10 Gbps.

In some embodiments, the control computer 135 may perform operations to monitor data stream rates, or, for example, buffer, cache, and/or packetize data to be transmitted. In an example, the control computer 135 may be network-processor-unit (NPU) based such that it can perform operations to inspect and modify packets on the fly at up to 10 Gbps or more (e.g., at least 15 Gbps, 20 Gbps, 25 Gbps, or up to 100 Gbps). In some implementations, the control computer 135 may include dedicated hardware to handle certain operations substantially in real time at line speed data rates (e.g., at least 10 Gbps). For example, dedicated hardware may perform operations such as switching fabrics, managing traffic, and/or network processing. Such dedicated hardware may be, for example, a chassis-based router-like device that connects on one side with the land world (e.g., 10 GbE) and on the other with wireless link via an embodiment of a photonics platform such as the transmitter 900, for example. In some examples, the various components of the transmitter 900 may cooperate to perform internal packet-processing substantially at or above line speed.

In an example, connections between the data interface 130 and the control computer 135 can be configured to process fast enough to handle continuous streaming of the data 30. For example, the data interface 130, control computer 135, and relevant connections can be capable of transferring and processing the data 30 at rates of 20 Gbps if 10 Gbps data (e.g., 10 GbE) is input to the data interface 130. In an illustrative embodiment, the transmitter 900 can include an embedded server (e.g., a blade server), which has high speed switch fabrics and network processing units that can handle at least 40 Gbps at the switching level, to perform some or all of the functions of the data control interface 130 and the control computer 135.

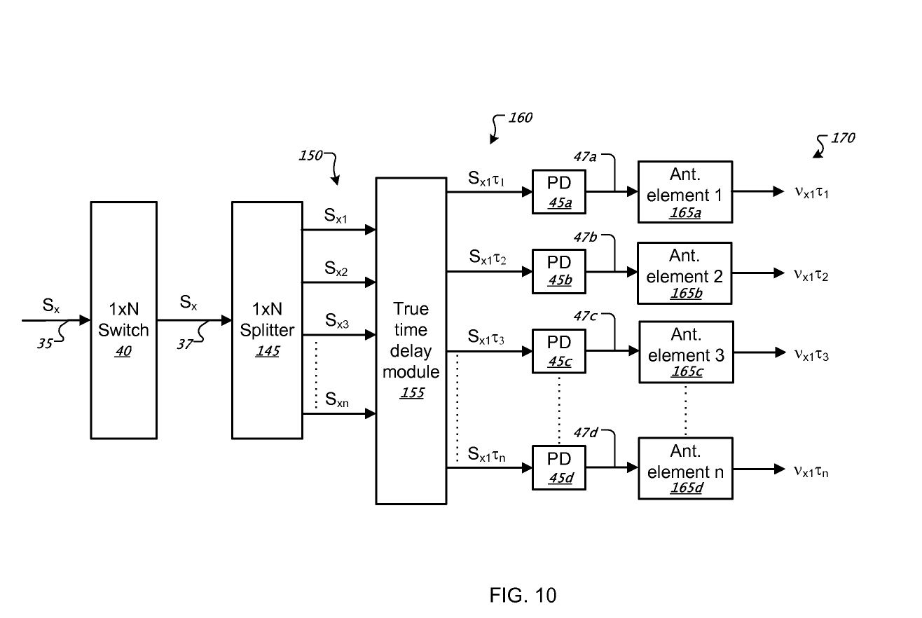

FIG. 10 shows an example of a transmitter with a photonic true-time delay module 155, which may optionally be included in various embodiments. FIG. 10 includes a 1×N splitter 145, a true-time delay module 155, photodiodes 45a-45d, and antenna elements 165a-165d. In this example, a transmitter may include the photonic true-time delay module 155 after the 1×N switch 40 and before the photodiodes 45a-45d. The photonic true-time delay module 155 provides beam forming and steering capabilities for one or more of the desired carrier frequencies 55a-55d (e.g., v₁-vₙ).

For example, modulated optical signal 37 coming from the 1×N switch 40 is input into the 1×N splitter 145. The 1×N splitter 145 splits the modulated optical signal 37 into multiple modulated optical signals 150 (e.g., Sₓ₁-Sₓₙ). The multiple modulated optical signals 150 can then enter the photonic true-time delay module 155 where separate time-delay components (e.g., τ₁-τₙ) may be added to each of the multiple modulated optical signals 150 resulting in multiple time-delayed modulated optical signals 160 (e.g., Sₓ₁τ₁-Sₓ₁τₙ). The multiple time-delayed modulated optical signals 160 (e.g., Sₓ₁τ₁-Sₓ₁τₙ) can impinge on photodiodes 45a-45d respectively. The resulting output electrical signals 47a-47d from the photodiodes 45a-45d can enter antenna elements 165a-165d respectively.

The antenna elements 165a-165d form a beam 170 consisting of multiple time-delayed elements (e.g., vₓ₁τ₁-vₓ₁τₙ) of the selected carrier frequency (e.g., vₓ₁). If the time elements of the beam 170 are different, then the beam 170 can be steered in different directions. The beam steering capability can enable point to multi-point transmission and reception without failure-prone moving parts.

Examples of the photonic true-time delay module 155 may include planar lightwave circuits (PLCs), electro-optic or thermo-optic switches, microelectro-mechanical switches (MEMS), and fiber loops of varying length. Various examples are described in the following references: E. J. Murphy, et al. “Guided-Wave Optical Time Delay Network,” IEEE Photon. Tech. Lett. 8(4), 545-547 (2006); J. Stulemeijer, et al. “Compact Photonic Integrated Phase and Amplitude Controller for Phased-Array Antennas,” IEEE Photon. Tech. Lett, 11(1), 122-124 (1999); and V. Kaman, et al. “a 32-Element 8-Bit Photonic True-Time-Delay System Based on a 288×288 3-D MEMS Optical Switch,” IEEE Photon. Tech. Lett. 15(6), 849-851 (2003).

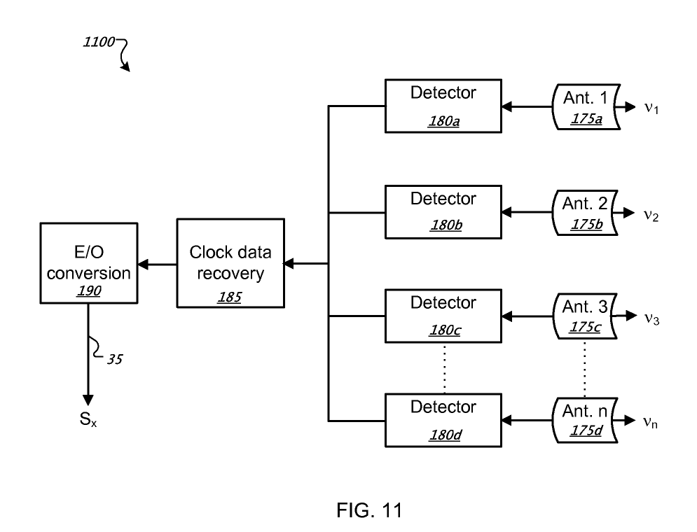

FIG. 11 shows an exemplary receiver 1100 for a wireless communication system. The receiver 1100 may be operative to receive information from various embodiments of the transmitters described above. The receiver 1100 includes millimeter-wave antennas 175a-175d, envelope detectors 180a-180d, a clock-data recovery unit 185, and an electrical-to-optical (E/O) conversion unit 190.

Millimeter-wave antennas 175a-175d receive the wireless signal of the selected carrier frequency (e.g., v₁-vₙ). The envelope detectors 180a-180d detect the envelopes of the signal for the selected carrier frequency (e.g., approximately 35 GHz band, 94 GHz band, 140 GHz band or 220 GHz band). The clock-data recovery unit 185 recovers the clock for the data. The E/O conversion unit 190 converts the electrical signal back into the modulated optical signal 35. The transceiver 1100 may include additional components. For example, a video switch may be used to condition the signal before the clock-data recovery unit 185 by placing limits on the bandwidth of the detected signal depending on which carrier frequency band the signal is being received on. In another example, a low-noise amplifier may be used to raise the signal level to prepare it for processing before the clock-data recovery unit 185. In another example, a transimpedance amplifier may be used after antennas 175a-175d and after the detectors 180.

In an illustrative example, a wireless transceiver system may communicate in a frequency band centered around 140 GHz with a bandwidth of 10 GHz, which involves a frequency range of between about 135 GHz and 145 GHz. If the transmission is performed in the lower 5 GHz (e.g., 135-140 GHz) and reception is performed in the upper 5 GHz (e.g., 140-145 GHz), then a stop band may be implemented between the upper and lower portions of the frequency band. In one implementation example, the signal may be structured for transmission between about 135-139.5 GHz, and for reception between about 140.5-145 GHz. In this example, source encoding may be implemented to support data traffic within about 4.5 GHz of effective bandwidth for simplex communication.

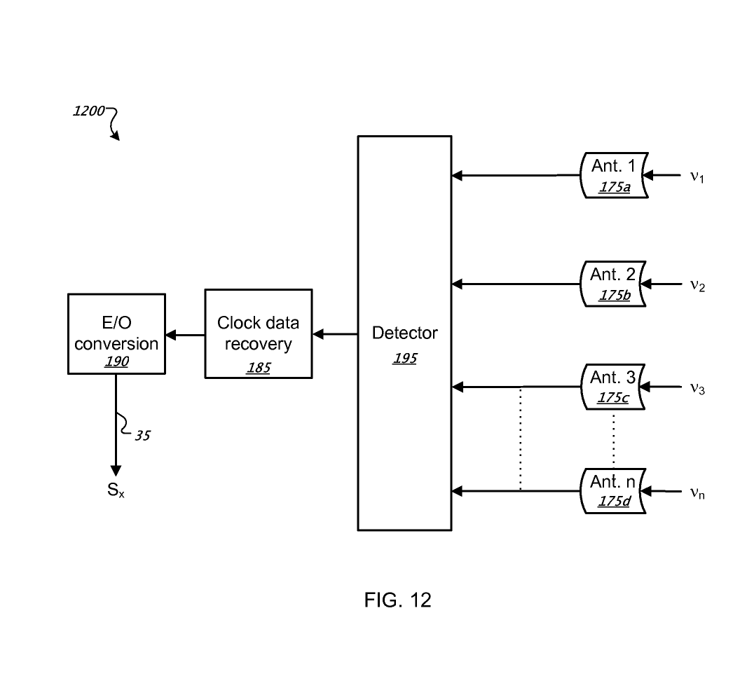

FIG. 12 shows an example of a receiver 1200, which includes a broadband envelope detector 195 coupled to multiple antennas 175a-175d. The receiver 1200 may be used with the example transmitters previously described. Appropriate interface electronics may (i) handle the significant amplification needed, (ii) ensure signal integrity at high data rates, and (iii) prepare the differential signaling that is needed for E/O interface when applicable with serialized optical interface real world line-card adapters, and the like.

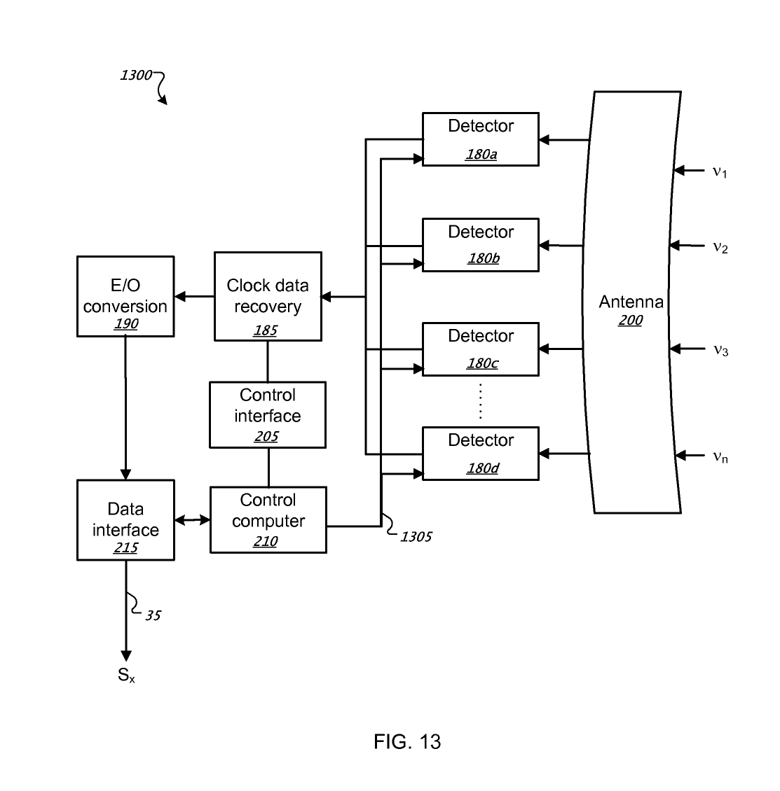

FIG. 13 shows an example of a receiver 1300, which includes a broadband antenna 200 and multiple detectors 180a-180d. The receiver 1300 may be used with the example transmitters previously described. The receiver 1300 includes broadband antenna 200, envelope detectors 180a-180d, clock-data recovery unit 185, E/O conversion unit 190, data interface 215, control interface 205 and control computer 210. The broadband antenna 200 is coupled to the envelope detectors 180a-180d. The CDR subsystem 185 may process one data stream on one carrier frequency, for example, or simultaneously process one or more data streams on multiple carrier frequencies. The control interface 205, the control computer 210, and the data interface 215 are used to send the received data. The control computer 210, in the example depicted in FIG. 13, has control lines coupled to each of the detectors 180a-180d. In an exemplary operation, the control computer 210 may intelligently supervise the selection of operating frequency band.

Exemplary wireless transceiver systems may include a transmitter and a receiver arranged to communicate over a wireless link. In such a transceiver system, transmitter control computers (e.g., the control computer 135), receiver control computers (e.g., the control computer 210), transmitter control interfaces (e.g., control interface 125), receiver control interfaces (e.g., control interface 205), transmitter data interfaces (e.g., data interface 130), and receiver data interfaces (e.g., data interface 215), and various auxiliary and signal path components may be combined or separated in various combinations.

In some examples, transceiver control may include adaptive intelligence. Some embodiments may include adaptive transceiver intelligence with measurement consolidation and management logic coupled with supervisory (potentially learning) decision-taking logic. One exemplary embodiment may use an approach that is at least partially manual, where an operator continuously follows the evolution of various parameters, based on actual periodic, automatic, or manually executed measurements, e.g., BER (bit error rate), bias current drift, output power levels, active carrier frequency band, and the like. In some implementations, feedback may be obtained from in-band management procedures between site A transceiver and site B transceiver in an A-to-B link decisions are taken as to what potentially to change in the link configuration and how to do this in synchronization between the two sites. In some embodiments, this same “intelligence” may encode the adaptive mechanisms with which a supervisory CPU (e.g., controlling computer and associated program instructions stored in a data storage device such as a non-volatile memory) assumes real-time ongoing control and management of a link.

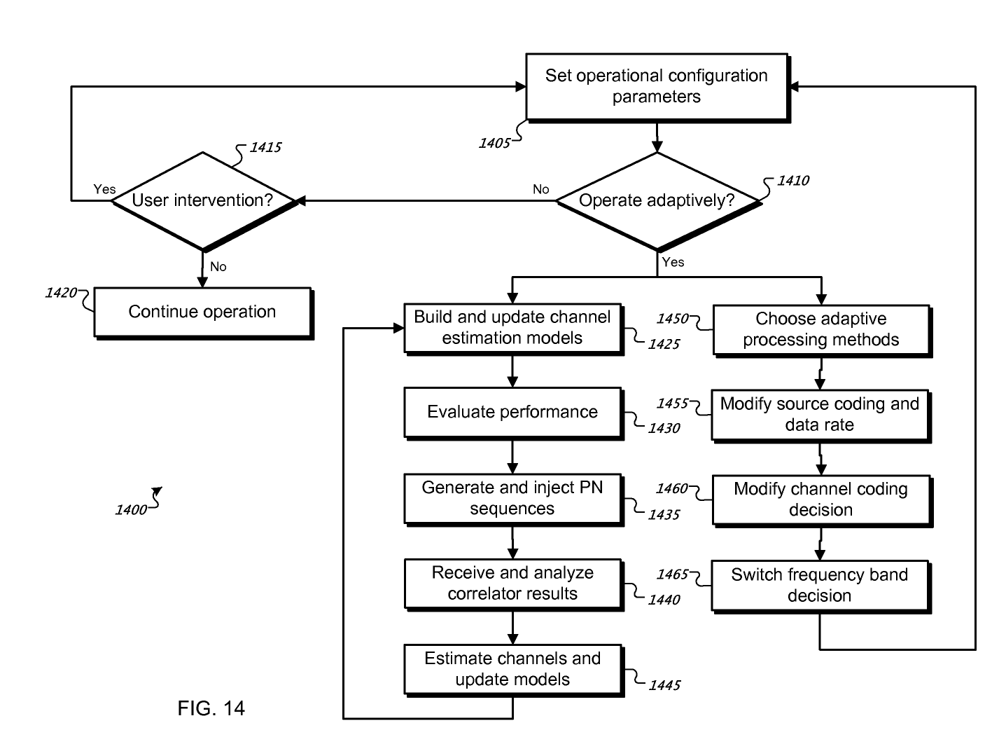

FIG. 14 shows exemplary operations for a supervisory adaptive transceiver management and control engine. The method 1400 begins by setting operational configuration parameters 1405. Next it is determined if the method 1400 should operate adaptively 1410. If no, it is next determined if there has been any user intervention 1415. If no, the operation continues 1420. If yes, the method 1400 sets operational configuration parameters 1405 and continues.

If, at step 1410, it is determined that the method 1400 can operate adaptively 1410, then channel estimation models are built and updated 1425. Performance is evaluated 1430, and PN sequences are generated and injected 1435. Next correlator results are received and analyzed 1440. Channels are estimated and models are updated 1445. The method 1400 then proceeds to step 1425 and continues.

If it is determined that the method 1400 can operate adaptively 1410, an adaptive processing method is chosen 1450. Source coding and data rate may be modified 1455. The decision whether to modify channel coding 1460 may be made prior to the decision whether to switch carrier frequency bands 1465. The method 1400 then proceeds to step 1405 where operational configuration parameters are set and the method 1400 continues.

The approach depicted in FIG. 14 is based upon a serial in-band management scheme. More specifically, specific PN sequences (of sufficient length in order to avoid probabilistic collision with actual traffic sequences) may be generated and some of them may be catalogued as valid commands between the two communicating sites. Transceivers at both sites may store and be configured to understand the PN sequences. Deterministic PN sequence generators and fast digital correlators can be implemented at the data input and data output ports, respectively. Supervision logic may then be implemented to coordinate these resources at the system level.

Deterministic but pseudo-random sequences may be generated at each site based on the needs of the specific protocols that may be executed on each occasion. Buffered look-up tables, for example, may keep a copy of the available commands (bit sequences) and the digital correlators at each receiver may be continuously scanning the incoming traffic for specific commands that will be detected when the corresponding bit sequences are detected in the arriving bit stream. Arrival of a command sequence may flag an appropriate event and a corresponding routine may then be executed, and/or a specific piece of hardware may be activated.

For example, such an infrastructure may use a simple handshake protocol between the two sites. The protocol may be used to change any specific characteristic of the link in real time and maintain substantial synchronization between the two sites.

For example, upon link establishment, a mathematically robust protocol can be used to combine the industry-standard Diffie-Hellman cryptographic protocol based upon which the two sites can exchange the results of a “lottery” process and whoever wins that contest (e.g., coming up with a modulo-arithmetic random number that is perhaps larger than the random number generated by the other site) will become the undisputed link's Master, automatically relegating the other site to a role of Slave. The Master then is the only one who could initiate handshake protocols for the change of parameters like carrier frequency band, or output power levels, etc. The Slave would have to provide periodic quality-of-link measurements (e.g., BER readings) to the Master who will decide if and when to change such configuration parameters.

As part of the measurement process, the Master may periodically inject specific parameterized commands and deterministic pseudo-random test vectors that the other site can easily identify whether they have been received correctly or not. This way, the BER calculations can take place in an accelerated fashion, so as to detect degradation or improvement in the channel conditions due to, for example, weather phenomena or the like. Once communicated back to the link Master, these results may (or may not) lead the decision engine of the Master to require the adjustment of the power output at one of the sites, or to switch the carrier frequency band of operation, or to increase or decrease the bit rate, for example. These parameter changes may be synchronized by the engagement of a parameterized handshake protocol that is initiated through appropriate command structures by the Master in a way that is understood by the Slave.

In one example, a distributed feedback (DFB) laser operating at 1550 nm may be connected to an electro-optic polymer modulator that is overdriven with a selected voltage at a selected carrier frequency to produce at least a pair of sidebands having a difference equal to the desired carrier frequency of 35 GHz (e.g., a pair of sidebands separated by 35 GHz). The modulator can be further overdriven to produce sideband pairs that have a difference corresponding to the higher carrier frequencies of 94 GHz and 140 GHz. Since other sidebands are typically present and need to be filtered out, the electro-optic modulator may be connected with an optical fiber to the input of an arrayed waveguide grating (AWG) that channelizes some or all sidebands. The two AWG outputs that correspond to the sidebands separated by 35 GHz may be connected to a 2 to 1 optical combiner, the two AWG outputs that correspond to the sidebands separated by 94 GHz may connected to a 2 to 1 optical combiner, and the two AWG outputs that correspond to the sidebands separated by 140 GHz may be connected to a 2 to 1 optical combiner to give optical channels for the 35 GHz, 94 GHz, and 140 GHz sideband pairs, respectively. The AWG and the three 2 to 1 combiners may be silicon waveguides that are integrated on one chip. Each of the three optical channels may be connected via optical fiber to a 3×1 optical switch, the “carrier frequency selector,” that is used to select the desired carrier frequency (e.g., sideband pairs) of 35 GHz, 94 GHz, or 140 GHz. The output of the 3×1 switch is connected via optical fiber to an optical modulator used to encode a multi-Gbps digital data stream on the 35 GHz, 94 GHz, or 140 GHz sideband pairs. The output of the electro-optic modulator is connected via optical fiber to an Erbium doped fiber amplifier (EDFA). The output of the EDFA is connected via optical fiber to the input of a 1×3 optical switch that routes the sideband pairs to either a dedicated 35 GHz, 94 GHz, 140 GHz, or 220 GHz photodiode detector based on the respective channel chosen at the carrier frequency selector. The 35 GHz, 94 GHz, and 140 GHz signals generated at the photodiodes are each sent to dedicated antennas for broadcast.

In various embodiments, adaptations may include other features and capabilities. Nevertheless, it will be understood that various modifications may be made. For example, various embodiments employ optical communication systems or sub-systems, including, for example, electro-optic modulators. Exemplary aspects of optical communication systems are described in further detail in U.S. Pat. No. 6,750,603, “Second order nonlinear optical chromospheres and electro-optic devices therefrom,” to Huang, et al., issued Jun. 15, 2004, the disclosure of which is incorporated herein by reference. Exemplary aspects of optical communication systems are also described in further detail in U.S. Pat. No. 6,822,384, “Design and synthesis of advanced NLO materials for electro-optic applicators,” to Huang, et al., issued Nov. 23, 2004, and in U.S. Pat. No. 6,716,995, “Design and synthesis of advanced NLO materials for electro-optic applications,” to Huang, et al., issued Apr. 6, 2004, the disclosures of which are also incorporated herein by reference.

Sophisticated applications (e.g., high-definition video or TV, Gigabit Ethernet (GbE) LAN (local area network) traffic, etc.) may benefit from reliable wireless transmission at very high bit rates and/or symbol rates. To transmit a certain number of symbols per second, a signal's carrier frequency is typically substantially larger than the highest frequency component of the underlying baseband signal. This may allow, for example, the receiver circuits to receive multiple periods of the received sinusoidal carrier signal before determining the most likely value of the actual symbol. For example, a data stream that includes a 1 Gbps (baseband) data signal may be transmitted using a wireless carrier frequency of about 10 GHz. In this example, the ratio of carrier frequency to the highest baseband frequency is 10. Although factors such as scattering and atmospheric absorption of specific frequencies may influence the effectiveness of the ratio, a higher ratio generally improves the effectiveness of the transmission.

Some embodiments relate to a photonic-technology-based architecture and implementation of a millimeter-wave transceiver that are capable of transmitting and receiving baseband information of data rates in excess of 10 Gbps (full-duplex in each direction) under all types of weather in point-to-point line-of-sight (LOS) contexts with a range of up to 6 kilometers (4 miles) of distance between transmitter and receiver.

Some embodiments relate to an architecture and/or implementation methods for optically-based wireless transceivers that can perform data transfers at rates of, for example, about 10, 20, 30 or at least about 40 Gbps. Some implementations may provide advantages over some conventional systems. For example, reliability may be increased, operating power consumption may be decreased, size and/or weight may be reduced, and achievable data rates may be increased substantially above, for example, a few Gbps.

For example, some embodiments may provide millimeter wave carrier frequencies (or higher) to transmit a 10-40 Gbps baseband signal (e.g., on Internet backbone router connections) over the air via radio communications. Millimeter waves may generally include frequencies between about 100 GHz and about 300 GHz, where wavelengths are generally on the order of a millimeter. Although the transceiver's operations are based on photonic technologies and predominantly optical signal processing, the transmission itself involves modulating baseband information upon a millimeter-wave radio signal.

In various embodiments, the millimeter-wave transceiver is capable of multi-band operations. The transceiver may switch frequencies (e.g., by selecting a particular optical signal, P₁-Pₙ 10) based on information about the channel conditions. The information used to switch frequencies may comprise information about natural phenomena (e.g., changes in weather that cause attenuation by scattering/absorption) or man-induced phenomena (e.g., interference that affects the data quality in the signal without effecting the signal attenuation, which may occur from electronic countermeasures or jamming). In some examples, the transceiver may transmit and/or receive at one or more selected carrier frequencies or bands of carrier frequencies. In particular, each frequency window may contain a frequency at which a local minimum occurs in the signal attenuation characteristic. In some embodiments, any of the frequency windows may be substantially centered, for example, on a linear or log frequency scale. The degree of signal attenuation and frequency at which the local minimum signal attenuation occur may vary due to conditions. For example, attenuation and local frequency minima may depend on changing humidity levels in the atmosphere such as, for example, in the frequency bands centered at about 35 GHz, 94 GHz, 140 GHz, and 220 GHz. The first three of these bands may be referred to as 35 GHz band, 94 GHz band, 140 GHz band, and 220 GHz band. Various embodiments may include optical or millimeter-wave amplifiers inserted in one or more of the links between components. For example, a high-gain erbium-doped fiber optical amplifier (EDFA) could be placed between the data optical modulator 25 and the 1×N switch 40 to amplify the modulated optical signal 35. In another embodiment, a millimeter-wave power amplifier may be inserted between photodiodes 45a-45d and the antennas 50a-50d. Some embodiments comprise the use of both an EDFA placed between the data optical modulator 25 and the 1×N switch 40 and a millimeter wave power amplifier inserted between photodiodes 45a-45d and the antennas 50a-50d.

In an exemplary embodiment, a platform may transmit real-time high-speed data at rates above about 10 Gbps. Such a platform may be used to design and build systems and converged video/voice/data applications that deliver extremely high bandwidth for contexts that require it. Furthermore, such a platform may reduce deployment cost, for example, in areas where optical fiber may be impractical or more expensive. Representative environments in which such platforms may be advantageous include, but are not necessarily limited to: bridges/switches/routers linking multiple 10 GbE networks in a line-of-sight campus, suburban, or metropolitan-area setting; flexible transport where needed or applicable of 10 Gbps (e.g., OC-192) SONET traffic that may occur at slightly different rates than 10 GbE; distribution of very-high definition video; HDTV (high definition television) distribution at the so-called last mile; storage area networks (SAN); server farm interfaces; tele-radiology in remote medicine settings; back-haul of cellular telephone networks; and, quick backup high-speed connectivity service restoration in areas affected by emergency situations or natural disasters.

In some implementations, selected carrier frequency bands may be centered at carrier frequencies that may include, but are not necessarily limited to, about 35 GHz, 94 GHz, 140 GHz, and 220 GHz. These exemplary carrier frequency bands correspond to reduced attenuation windows in atmospheric models for millimeter-wave transmission.

The bandwidth actually used by a transceiver in operations depends, at least in part, on the actual source encoding method. For example, a simple return-to-zero (RZ) coding used on a 10 Gbps baseband signal may use a bandwidth of 20 GHz centered on the selected carrier frequency band. More spectrally efficient ways of source coding techniques, for example, may be used to reduce this bandwidth even further.

Various embodiments may provide tunable mechanisms for adapting the system performance in a way that satisfies performance specifications, which may relate to power, spectrum, distance, noise, channel and/or weather conditions, for example.

The adaptive communication capabilities of the transceiver may be enabled by a controlling computer, which may be packaged or housed with the transceiver. Such a controller may control system-related parameters, such as the selected carrier frequency band, the bit rate to satisfy signal-to-noise ratio requirements, the transmitted output power (e.g., to adapt to the weather conditions or required range of transmission), and/or the source and channel coding mechanism (e.g., to mitigate specific bit errors). Some embodiments may control other parameters, such as bias drift on electro-optic modulator devices in the photonics-based wireless transceiver implementation.

Some embodiments may provide a platform for subsequent software-intensive development by communications and networking equipment OEMs (original equipment manufacturers), who can deploy their protocol and application software on top of this photonic engine. Various embodiments may have reduced implementation cost and/or improved commercial viability sufficient to implement some broadband applications that, for example, use extremely high-speed connectivity.

In one embodiment, the transceiver includes two electro-optical modulators. A first modulator in the transceiver may generate appropriate spectral sidebands that can be appropriately combined in the transmitter prior to the signal's change from the optical to the radio-electrical domain. A second modulator may be used for the actual baseband data feed into the transmitter. The transceiver and associated components may be assembled and deployed as a platform for the development and deployment of unique very-high-speed wireless communication systems. These systems may include or be adapted to include associated firmware and appropriate systems and application software.

In various embodiments, a transceiver system may include: (i) a transmitter (Tx) and (ii) a receiver (Rx) unit. Depending on how the transceiver operates, meaning for example that it may be configured to transmit in one specific band and receive on the same band in intermittent alternative Tx/Rx time slots or it may be configured to receive simultaneously to transmitting, but on a completely different carrier frequency band, the overall management of a combination of a transmitter and a receiver is called a transceiver.

In various embodiments, advantageous results may be achieved if the steps of the disclosed techniques were performed in a different sequence, if components in the disclosed systems were combined in a different manner, or if the components were replaced or supplemented by other components. The functions and processes (including algorithms) may be performed in hardware, software, or a combination thereof, and some implementations may be performed on modules or special network processor hardware not identical to those described. Accordingly, other implementations are contemplated.

What is claimed is:

1. An optically-based wireless communication system capable of switching among multiple different carrier frequency bands during operation, the system comprising:
an optical selector module configured to output one of a plurality of optical signals in response to an optical selection signal, the selected optical signal corresponding to one of a plurality of non-overlapping carrier frequency bands;
a modulator stage to encode data onto the selected optical signal; and
a transmit stage to transmit the data over a wireless path at a carrier frequency generated by the selected optical signal.

2. The system of claim 1, further comprising a control module to generate the optical selection signal according to a selected carrier frequency band for wireless communication.

3. The system of claim 2, wherein the control module selects the carrier frequency band based on information about wireless channel conditions of at least one of the carrier frequency bands.

4. The system of claim 2, wherein the control module selects the carrier frequency band based on error information associated with the wireless path.

5. The system of claim 1, wherein the optical selector module comprises an optical switch.

6. The system of claim 1, wherein the optical selector module comprises an optical combiner.

7. The system of claim 1, further comprising a second optical selector module configured to couple the modulated optical signal to a selected one of a plurality of optical-to-electronic conversion devices.

8. The system of claim 7, wherein the transmit stage comprises a plurality of antennas, each antenna being operatively coupled to one of the plurality of optical-to-electronic conversion devices.

9. An optically-based wireless communication system capable of switching among multiple different carrier frequency bands during operation, the system comprising:
a controlled stage to output a selected optical signal corresponding to a carrier frequency within one of a plurality of different carrier frequency bands, the optical signal being selected in response to a control input;
a modulator stage to encode digital data onto the selected optical signal; and
a transmit stage to transmit the data over a wireless path at a carrier frequency generated by the selected optical signal.

10. The system of claim 9, wherein each of the plurality of carrier frequency bands is substantially centered near a frequency that is a member of the group consisting of: GHz; 94 GHz; 140 GHz; and 220 GHz.

11. They system of claim 9, wherein each of the carrier frequency bands includes one member selected from the group consisting of: 35 GHz; 94 GHz; 140 GHz; and, 220 GHz.

12. The system of claim 9, wherein the carrier frequency bands do not overlap.

13. The system of claim 9, further comprising an optical-to-electronic converter for converting the modulated signal from an optical format to an electrical format.

14. An optically-based wireless communication system, the system comprising:
means for selecting one of a plurality of optical signals that corresponds to one of a plurality of carrier frequencies, the selecting including determining which carrier frequency has a desired transmission characteristic among the plurality of carrier frequencies during operation; and
a modulator stage to encode data onto the selected optical signal.

15. The system of claim 14, further comprising means for transmitting the data over a wireless path at a carrier frequency of the selected optical signal.

16. The system of claim 14, wherein the selecting means comprises means for generating a carrier frequency for the wireless transmission.

17. The system of claim 14, further comprising means for controlling the selecting means.

18. The system of claim 14, further comprising means for converting the selected optical signal to an electrical signal.
